(19) United States
(12) Patent Application Publication
(10) Pub. No.: US 2011/0128337 A1
(43) Pub. Date: Jun. 2, 2011

(54) MEDIA TRANSPORT SYSTEM FOR NON-CONTACTING PRINTING

(76) Inventors: Christopher M. Muir, Rochester, NY (US); Randy E. Armbruster, Rochester, NY (US); Bradley C. DeCook, Rochester, NY (US); Brian J. Joseph, Spencerport, NY (US)

(21) Appl. No.: 12/627,018

(22) Filed: Nov. 30, 2009

(51) Int. Cl. B41J 2/01

(52) U.S. Cl. 347/104

(57) ABSTRACT

A digital printing system for printing on a continuous web of print media includes a support structure that guides the continuous web of print media under tension through the printing system. The printing system includes a first mechanism that is affixed to the support structure that positions the print media in a cross track direction. A second mechanism is affixed to the support structure that sets tension of the print media. A third mechanism is affixed to the support structure that sets an angular trajectory of the print media. A roller is affixed to the support structure and is configured to align to the print media being guided through the printing system without necessarily being aligned to another roller located upstream or downstream relative to the roller. A drive roller is affixed to the support structure that moves the print media through the printing system. A printhead is located downstream relative to the first mechanism. The printhead is configured to selectively moisten at least a portion of the print media being guided through the printing system without contacting the print media.

### CROSS REFERENCE TO RELATED APPLICATIONS

Reference is made to commonly-assigned copending U.S. patent application Ser. No. ______ (Docket No. 95529) filed ______ entitled “MODULAR MEDIA TRANSPORT SYSTEM”, by DeCook et al.

### FIELD OF THE INVENTION

The present invention generally relates to printing apparatus for web media and more particularly relates to a printing apparatus having an arrangement of components that do not require precision alignment for feeding a continuous web of media from a supply through one or more printing sections and to a take-up section.

### BACKGROUND OF THE INVENTION

Continuous web printing allows economical, high-speed, high-volume print reproduction. In this type of printing, a continuous web of paper or other substrate material is fed past one or more printing subsystems that form images by applying one or more colorants onto the substrate surface. In a conventional web-fed rotary press, for example, a web substrate is fed through one or more impression cylinders that perform contact printing, transferring ink from an imaging roller onto the web in a continuous manner.

Proper registration of the substrate to the printing device is of considerable importance in print reproduction, particularly where multiple colors are used in four-color printing and similar applications. Conventional web transport systems in today's commercial offset printers address the problem of web registration with high-precision alignment of machine elements. Typical of conventional web handling subsystems are heavy frame structures, precision-designed components, and complex and costly alignment procedures for precisely adjusting substrate transport between components and subsystems.

The problem of maintaining precise and repeatable web registration and transport becomes even more acute with the development of high-resolution non-contact printing, such as high-volume inkjet printing. With this type of printing system, finely controlled dots of ink are rapidly and accurately propelled from the printhead onto the surface of the moving media, with the web substrate often coursing past the printhead at speeds measured in hundreds of feet per minute. No impression roller is used; synchronization and timing are employed to determine the sequencing of colorant application to the moving media. With dot resolution of 600 dots-per-inch (DPI) and better, a high degree of registration accuracy is needed. During printing, variable amounts of ink may be applied to different portions of the rapidly moving web, with drying mechanisms typically employed after each printhead or bank of printheads. Variability in ink or other liquid amounts and types and in drying time can cause substrate stiffness and tension characteristics to vary dynamically over a range for different types of substrate, contributing to the overall complexity of the substrate handling and registration challenge.

One approach to the registration problem is to provide a print module that forces the web media along a tightly controlled print path. This is the approach that is exemplified in U.S. Patent Application No. 2009/0122126 entitled “Web Flow Path” by Ray et al. In such a system, there are multiple drive rollers that fix and constrain the web media position as it moves past one or more ink application printheads.

Problems with such a conventional approach include significant cost in design, assembly, and adjustment and alignment of web handling components along the media path. While such a conventional approach may allow some degree of modularity, it would be difficult and costly to expand or modify a system with this type of design. Each “module” for such a system would itself be a complete printing apparatus, or would require a complete, self-contained subassembly for paper transport, making it costly to modify or extend a printing operation, such as to add one or more additional colors or processing steps, for example.

Various approaches to web tracking are suitable for various printing technologies. For example, active alignment steering, as taught for an electrographic reproduction web (often referred to as a belt on which images are transported) in commonly assigned U.S. Pat. No. 4,572,417 entitled “Web Tracking Apparatus” to Joseph et al. would require multiple steering stations for continuous web printing, with accompanying synchronization control. It would be difficult and costly to employ such a solution with a print medium whose stiffness and tension vary during printing, as described above. Other solutions for web (or belt as referred to above) steering are similarly intended for endless webs in electrophotographic equipment but are not readily adaptable for use with paper media. Steering using a surface-contacting roller, useful for low-speed photographic printers and taught in commonly assigned U.S. Pat. No. 4,795,070 entitled “Web Tracking Apparatus” to Blanding et al. would be inappropriate for a surface that is variably wetted with ink and would also tend to introduce non-uniform tension in the cross-track direction. Other solutions taught for photographic media, such as those disclosed in commonly assigned U.S. Pat. No. 4,901,903 entitled “Web Guiding Apparatus” to Blanding are well suited to photographic media moving at slow to moderate speeds but are inappropriate for systems that need to accommodate a wide range of medias, each with different characteristics, and transport each media type at speeds of hundreds of feet per minute.

In order for high-speed non-contact printers to compete against earlier types of devices in the commercial printing market, the high cost of the web transport should be reduced. As such, there is a need for an adaptable non-contact printing system that can be fabricated and configured without the cost of significant down-time, complex adjustment, and constraint on web media materials and types.

### SUMMARY OF THE INVENTION

It is an object of the present invention to advance the art of web media handling in an imaging system. With this object in mind, the present invention applies kinematic design principles to transport a continuous web of media through a non-contact printing system.

According to one feature of the present invention, a digital printing system for printing on a continuous web of print media includes a support structure that guides the continuous web of print media under tension through the printing system. The printing system includes a first mechanism that is affixed to the support structure that positions the print media in a cross track direction. A second mechanism is affixed to the support structure that sets tension of the print media. A third mechanism is affixed to the support structure that sets an angular trajectory of the print media. A roller is affixed to the support structure and is configured to align to the print media being guided through the printing system without necessarily being aligned to another roller located upstream or downstream relative to the roller. A drive roller is affixed to the support structure that moves the print media through the printing system. A printhead is located downstream relative to the first mechanism. The printhead is configured to selectively moisten at least a portion of the print media being guided through the printing system without contacting the print media.

According to another feature of the present invention, a method of printing on a continuous web of print media includes guiding a continuous web of print media under tension through a printing system by: positioning the print media in a cross track direction using a first mechanism; setting a tension of the print media using a second mechanism; and setting an angular trajectory of the print media using a third mechanism; and causing the print media to move through the printing system using a drive roller. The method also includes selectively moistening at least a portion of the print media being guided through the printing system without contacting the print media using a printhead located downstream relative to the first mechanism.

One advantage of the present invention is that it allows the web media transport components to self-align to the continuously moving web in order to maintain registration of the printing media. Another advantage of the present invention is that it allows non-contact printing or, more generally, the application of fluid onto the media surface at high speeds, without applying an over-constraining force or pressure that might inadvertently damage the media, cause image misregistration, or otherwise inhibit proper drying or curing of applied inks and other fluids.

The invention and its objects and advantages will become more apparent in the detailed description of the example embodiments presented below. The invention is defined by the claims.

### BRIEF DESCRIPTION OF THE DRAWINGS

In the detailed description of the preferred embodiments of the invention presented below, reference is made to the accompanying drawings, in which:

FIG. 1 is a schematic side view of a digital printing system according to an example embodiment of the present invention.

FIG. 2A is a perspective view showing an orthogonal coordinate system used to characterize web media constraints.

FIG. 2B is a schematic top view showing angular and lateral constraints applied to a continuously moving web.

FIG. 3 is an enlarged schematic side view of media transport components of the digital printing system shown in FIG. 1.

FIG. 4 is a web plane diagram for the web transport path of the digital printing system shown in FIG. 3.

FIG. 5 is a top view showing the arrangement of rollers and surfaces within the turnover module in one example embodiment.

FIG. 6 is a web plane diagram for the turnover module of FIG. 5.

FIG. 7 is a schematic side view of a large-scale two-sided digital printing system according to another example embodiment of the present invention.

FIG. 8 is a web plane diagram for the web transport path of the digital printing system shown in FIG. 7.

FIG. 9 is a perspective view of a printing apparatus according to another example embodiment of the present invention, with covers and printhead and support components removed for better visibility.

FIG. 10 is a schematic side view of a digital printing system according to another example embodiment of the present invention.

FIG. 11 is a web plane diagram for the web transport path of the digital printing system shown in FIG. 10.

FIG. 12 is a schematic side view of a digital printing system according to another example embodiment of the present invention.

FIG. 13 is a web plane diagram for the web transport path of the digital printing system shown in FIG. 12.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The method and apparatus of the present invention provide a modular approach to the design of a digital printing system, utilizing features and principles of exact constraint for transporting continuously moving web print media past one or more digital printheads, such as inkjet printheads. The apparatus and method of the present invention are particularly well suited for printing apparatus that provide non-contact application of ink or other colorant onto a continuously moving medium. The printhead of the present invention selectively moistens at least some portion of the media as it courses through the printing system, but without the need to make contact with the print media.

In the context of the present disclosure, the term “continuous web of print media” relates to a print media that is in the form of a continuous strip of media as it passes through the printing system from an entrance to an exit thereof. The continuous web of print media itself serves as the receiving print medium to which one or more printing ink or inks or other coating liquids are applied in non-contact fashion. This is distinguished from various types of “continuous webs” or “belts” that are actually transport system components rather than receiving print media and that are typically used to transport a cut sheet medium in an electrophotographic or other printing system. The terms “upstream” and “downstream” are terms of art referring to relative positions along the transport path of a moving web; points on the web move from upstream to downstream.

Kinematic web handling is provided not only within each module of the system of the present invention, but also at the interconnections between modules, as the continuously moving web medium passes from one module to another. Unlike a number of conventional continuous web imaging systems, the apparatus of the present invention does not require a slack loop between modules, but typically uses a slack loop only for media that has been just removed from the supply roll at the input end. Removing the need for a slack loop between modules or within a module allows addition of a module at any position along the continuously moving web, taking advantage of the self-positioning and self-correcting design of media path components.

The apparatus and methods of the present invention adapt a number of exact constraint principles to the problem of web handling. As part of this adaptation, the inventors have identified ways to allow the moving web to maintain proper cross-track registration in a “passive” manner, with a measure of self-correction for web alignment. Steering of the web is avoided unless absolutely necessary; instead, the web's lateral and angular positions in the plane of transport are exactly constrained. Moreover, other web support devices used in transporting the web, other than non-rotating surfaces or those devices purposefully used to exactly constrain the web, are allowed to self-align with the web. The digital printing system according to this invention includes one or more modules that guide the web of print media as it passes at least one non-contact digital printhead. The digital printing system can also include components for drying or curing of the printing fluid on the media; for inspection of the media, for example, to monitor and control print quality; and various other functions. The digital printing system receives the print media from a media source, and after acting on the print media conveys it to a media receiving unit. The print media is maintained under tension as it passes through the digital printing system, but it is not under tension as it is received from the media source.

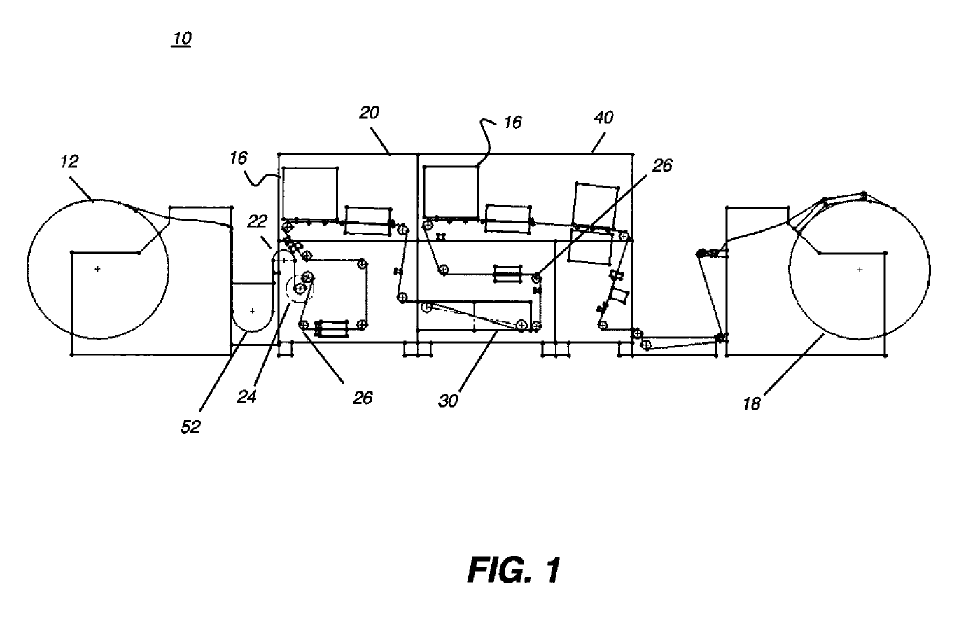

Referring to the schematic side view of FIG. 1, there is shown a digital printing system 10 for continuous web printing according to one embodiment. A first module 20 and a second module 40 are provided for guiding continuous web media that originates from a source roller 12. Following an initial slack loop 52, the media that is fed from source roller 12 is then directed through digital printing system 10, past one or more digital printheads 16 and supporting printing system 10 components. First module 20 has a support structure, shown in more detail subsequently, that includes a cross-track positioning mechanism 22 for positioning the continuously moving web of print media in the cross-track direction, that is, orthogonal to the direction of travel and in the plane of travel. In one embodiment, cross-track positioning mechanism 22 is an edge guide for registering an edge of the moving media. A tensioning mechanism 24, affixed to the support structure of first module 20, includes structure that sets the tension of the print media.

Downstream from first module 20 along the path of the continuous web media, second module 40 also has a support structure, similar to the support structure for first module 20. Affixed to the support structure of either or both the first or second module 20 or 40 is a kinematic connection mechanism that maintains the kinematic dynamics of the continuous web of print media in traveling from the first module 20 into the second module 40. Also affixed to the support structure of either the first or second module 20 or 40 are one or more angular constraint structures 26 for setting an angular trajectory of the web media.

Still referring to FIG. 1, printing system 10 optionally also includes a turnover mechanism 30 that is configured to turn the media over, flipping it backside-up in order to allow printing on the reverse side. The print media then leaves the digital printing system 10 and travels to a media receiving unit, in this case a take-up roll 18. A take-up roll 18 is then formed, rewound from the printed web media. The digital printing system can include a number of other components, including multiple print heads and dryers, for example, as described in more detail subsequently. Other examples of system components include web cleaners, web tension sensors, and quality control sensors.

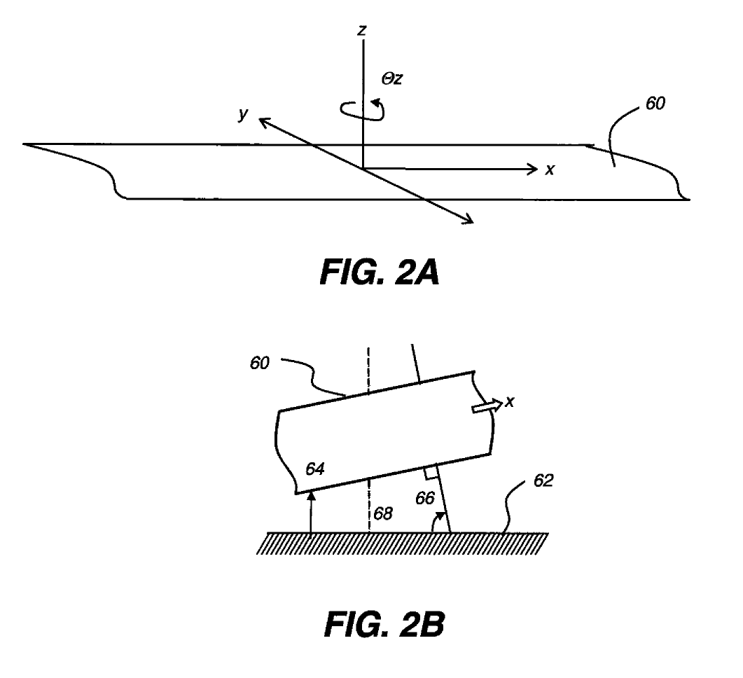

FIG. 2A shows a perspective view of a portion of the web path with orthogonal coordinates used herein to describe principles of web constraint. A moving web 60 is considered to be unconstrained in the x direction. Cross-track y direction is considered orthogonal to the x direction. Angular trajectory is described in terms of Θz, rotation about the orthogonal z axis.

FIG. 2B shows, in a schematic top view, symbols for exact constraint principles that are applied to a continuously moving web and are used for the apparatus and methods of the present invention. This type of drawing is commonly referred to as a web plane diagram. Moving web 60 is shown deliberately skewed with respect to the web support structure 62. A lateral constraint is denoted by an arrow from the web support structure 62 that contacts the edge of the moving web as shown at 64. An angular constraint is denoted by a solid line from the web support structure 62 that spans the web and is perpendicular to the web shown at 66. A support that provides no lateral or angular constraint on the web passing over it is denoted by a dashed line from the web support structure 62 that crosses the web at a non-perpendicular angle as shown at 68. This figure shows a combination of an upstream lateral constraint (64) and a downstream angular constraint (66) that is useful for providing a stable constraint condition. A number of related principles have also been found useful for maintaining exact constraint: These include the following:
(i) Web 60 tends to approach a roller at a 90 degree angle, as shown in FIG. 2B by the orthogonal symbol along the edge of web 60 at angular constraint 66.
(ii) Stationary curved surfaces impart no measurable cross-track force onto a moving web passing over it, and can be denoted by the dashed line as at 68.
(iii) Castered rollers allow the roller to rotate so that it is at a 90 degree angle to the approaching web. These also can be denoted in the web plane diagram as a dashed line as at 68.
(iii) Gimbaled rollers allow the web to maintain its preferred 90 degree angle approach and orientation to the next downstream roller along the web path. This is because the web exhibits considerable flexibility in twist. Since the gimbaled roller provides the flexibility needed for the web to align with the following roller, they are illustrated in web plane diagrams as a pivot allowing adjacent spans to have differing angles relative to the web support structure. At the same time, gimbaled rollers can be used to provide an angular constraint as the web approaches the gimbaled roller at a 90 degree angle.
(iv) Castered rollers can be used where it is desirable to impart no lateral or angular constraint to the moving web.
(v) Two edge guides within the same web span provide both lateral and angular constraint.

Within the printing apparatus of the present invention, the web is guided along its transport path through a number of rollers and curved surfaces. For each web span, both lateral constraint 64 and angular constraint 66 are necessary. However, adding an additional mechanism to achieve lateral or angular constraint can easily cause an over-constraint condition. Thus, for each web span that follows an initial lateral constraint along the web path, the constraint method employed by the inventors attempts to use, as its lateral “constraint”, the given cross track position of the web as it is received from the preceding web span.

Over each web span, then, an angular constraint is provided by a roller mechanism, as described in more detail subsequently. Not every roller along the web path applies angular constraint; in many cases it is advantageous to provide a castered roller or a stationary curved surface that is arranged to provide zero constraint.

Following principles such as these, the inventors have found that an arrangement of mechanisms can be provided to yield the stable constraint arrangement described with respect to FIG. 2B over each web span, so that web 60 itself maintains lateral position without external steering or other applied force. In addition, these same mechanisms operable at the interface of one web span to the next also apply at the interface as the web passes between one module and the next.

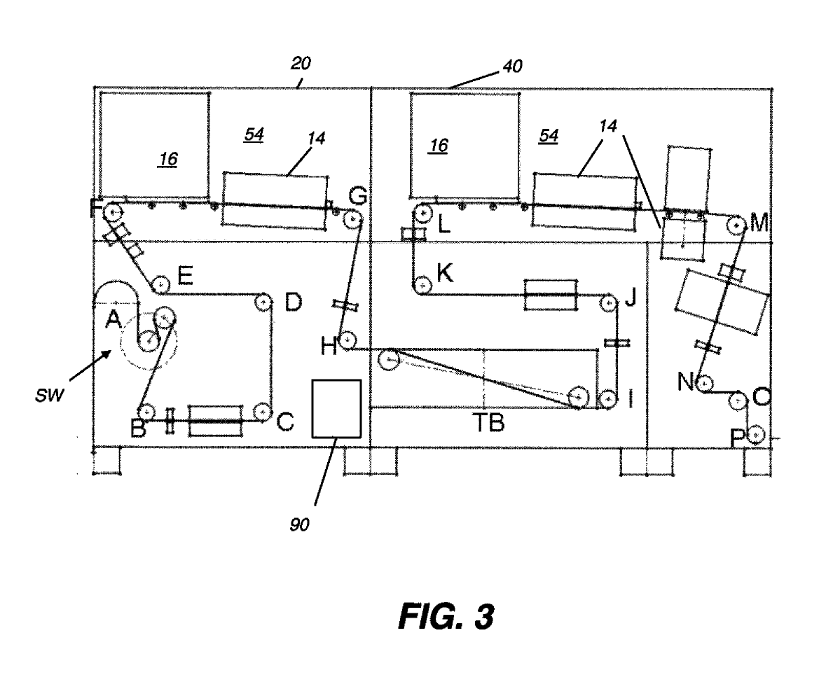

The schematic side view diagram of FIG. 3 shows, at enlarged scale from that of FIG. 1, the media routing path through modules 20 and 40 in one embodiment. Within each module 20 and 40, in a print zone 54, each print head 16 is followed by a dryer 34.

Table 1 that follows identifies the lettered components used for web media transport and shown in FIG. 3. An edge guide in which the media is pushed laterally so that an edge of the media contacts a stop is provided at A. The slack web entering the edge guide allows the print media to be shifted laterally without interference without being overconstrained. An S-wrap device SW provides stationary curved surfaces over which the continuous web slides during transport. As the paper is pulled over these surfaces the friction of the paper across these surfaces produces tension in the print media. In one embodiment, this device allows an adjustment of the positional relationship between surfaces, to control the angle of wrap and allow adjustment of web tension.

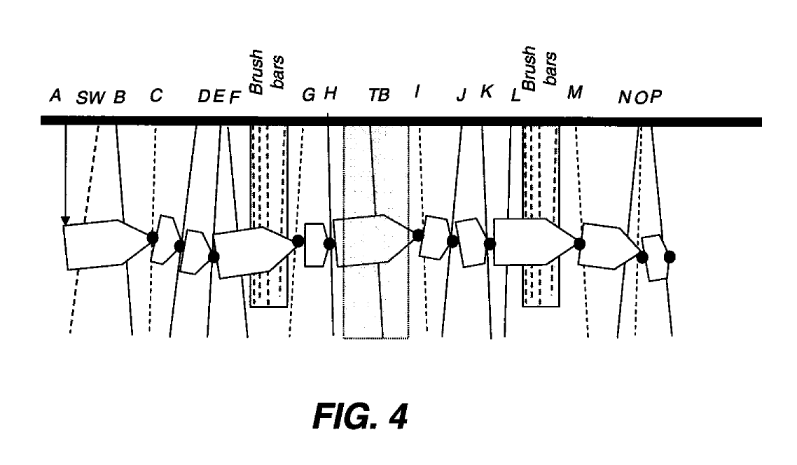

TABLE 1
Roller Listing for FIG. 3

| Media Handling | |
|---|---|
| Component | Type of Component |
| A | Lateral constraint (edge guide) |
| SW - S-Wrap | Zero constraint (non-rotating support). |
| | Tensioning. |
| B | Angular constraint (in-feed drive roller) |
| C | Zero constraint (Castered and Gimbaled Roller) |
| D* | Angular constraint with hinge (Gimbaled Roller) |
| E | Angular constraint with hinge (Gimbaled Roller) |
| F | Angular constraint (Fixed Roller) |
| G | Zero constraint (Castered and Gimbaled Roller) |
| H | Angular constraint with hinge (Gimbaled Roller) |
| TB (TURNOVER) | See FIG. 4 |
| I | Zero constraint (Castered and Gimbaled Roller) |
| J* | Angular constraint with hinge (Gimbaled Roller) |
| K | Angular constraint with hinge (Gimbaled Roller) |
| L | Angular constraint (Fixed Roller) |
| M | Zero constraint (Castered and Gimbaled Roller) |
| N | Angular constraint (out-feed drive roller) |
| O | Zero constraint (Castered and Gimbaled Roller) |
| P | Angular constraint with hinge (Gimbaled Roller) |

Note:
Asterisk (*) indicates locations of load cells.

The first angular constraint is provided by in-feed drive roller B. This is a fixed roller that cooperates with a drive roller in the turnover section and with an out-feed drive roller N in second module 40 in order to move the web through the printing system with suitable tension in the movement direction (x-direction). The tension provided by the preceding S-wrap serves to hold the paper against the in-feed drive roll so that a nip roller is not required at the drive roller. Angular constraints at subsequent locations downstream along the web are often provided by rollers that are gimbaled so as not to impose an angular constraint on the next downstream web span.

The web plane diagram of FIG. 4 schematically shows where various constraints are imposed along the media path shown in the side view of FIG. 3. The following notes help to interpret the diagram of FIG. 4 and to relate this schematic representation to the component arrangement shown in FIG. 3:
(i) There is a single lateral constraint mechanism used at A. Here, at the beginning of the media path, a single edge guide provides lateral constraint that is sufficient for registering the continuous web of print media along the media path. It is significant that only one lateral constraint is actively applied throughout the media path, here, as an edge guide. However, given this lateral constraint and the following angular constraint, the lateral constraint for each subsequent web span can be fixed. In one embodiment, a gentle additional force is applied along the cross-track direction as an aid for urging the media edge against the edge guide at A. This force is often referred to as a nesting force as the force helps cause the edge of the media to nest along side the edge guide. A suitable edge guide is described in commonly-assigned copending U.S. patent application Ser. No. ______ (Docket 95525) filed ______, entitled “EDGE GUIDE FOR MEDIA TRANSPORT SYSTEM”, by Muir et al.
(ii) Angular constraints are imposed onto the web path wherever there are solid lines shown across the web in the web plane diagram. Each angular constraint sets the angular trajectory of the web as it moves along. However, the web is not otherwise steered in the embodiment shown.
(iii) Fixed rollers at F and L precede the printheads for each module, providing the desired angular constraint to the web in the print zone. These rollers provide a suitable location of mounting an encoder for monitoring the motion of the media through the printing system.
(iv) Under the printheads, the print media is supported by fixed non-rotating supports. These supports provide zero constraint to the web.
(v) Roller G is a castered and gimbaled roller providing zero constraint. In FIG. 4, dashed lines indicate mechanisms that provide zero constraint, such as where stationary curved surfaces or castered rollers are used.
(vi) If the span between roller F and G is sufficiently long, the continuous web may lack sufficient stiffness to cause castered roller G to align properly with the web. In such cases, roller G need not be castered. Because of the relative length to width ratio of the media in the segment between F and G, the continuous web in that segment is considered to be non-stiff, showing some degree of compliance in the cross-track direction. As a result, an additional constraint can be included to exactly constrain that web segment. This can be accomplished by eliminating the caster from roller G.
(vii) Each discrete section between pivots of the web plane diagram represents a web span. As noted, in the recommended practice for exact constraint web handling design, each web span should align properly if it has exactly one lateral and one angular constraint. For most of the web spans, the exit lateral position of the previous or nearest upstream web span sets the lateral position of the web at the entrance to the next web span. Where needed, because ideal exact constraint is difficult to apply over every web span, an active steering mechanism can be used to determine lateral constraint.
(viii) Castered and gimbaled rollers provide zero constraint along the web path. These mechanisms are used, for example, near the input to each module, making each module independent of angular constraints from earlier mechanisms.
(ix) Axially compliant rollers could alternately be used where cross-track constraint is undesirable.

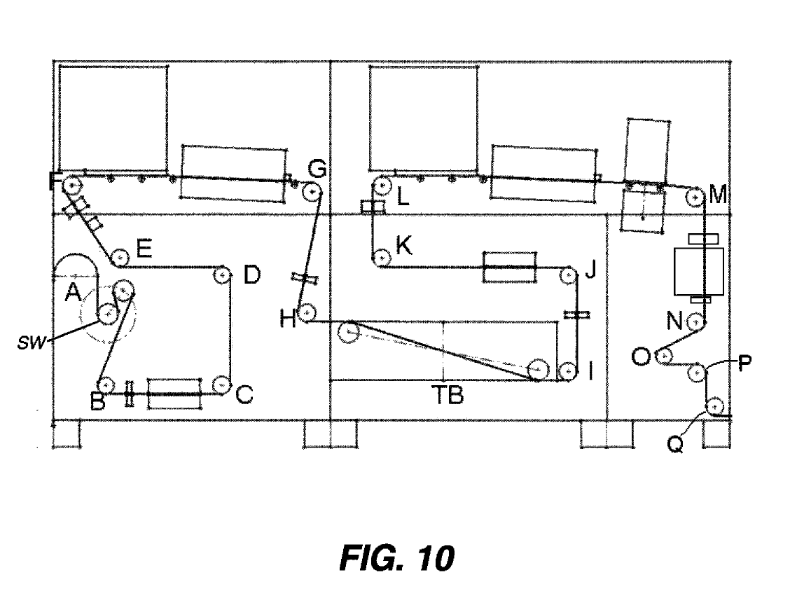

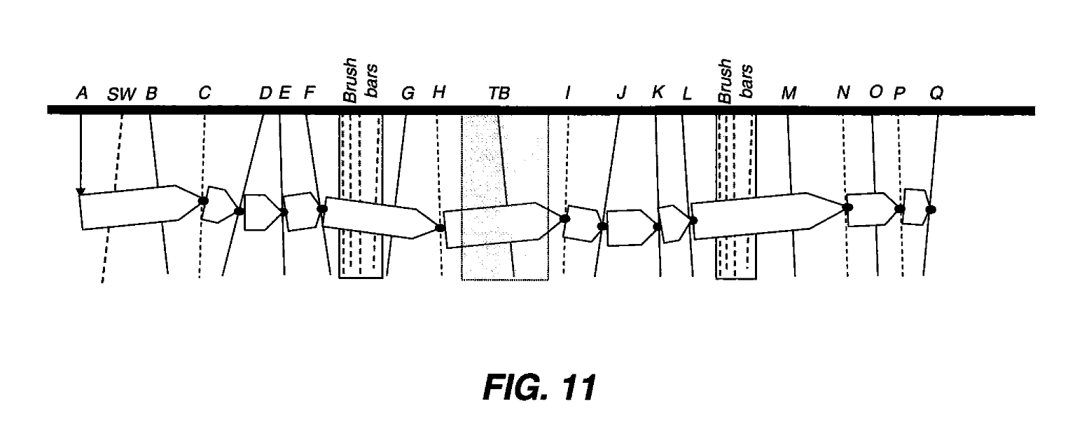

Table 2 that follows identifies the lettered components used for an alternative embodiment of the web media transport shown in FIG. 10. The web plane diagram of FIG. 11 schematically shows where various constraints are imposed along the media path and corresponds to the embodiment shown in FIG. 10.

TABLE 2
Roller Listing for FIG. 10

| Media Handling | |
|---|---|
| Component | Type of Component |
| A | Lateral constraint (edge guide) |
| SW - S-Wrap | Zero constraint (non-rotating support). |
| | Tensioning. |
| B | Angular constraint (in-feed drive roller) |
| C | Zero constraint (Castered and Gimbaled Roller) |
| D* | Angular constraint with hinge (Gimbaled Roller) |
| E | Angular constraint with hinge (Gimbaled Roller) |
| F | Angular constraint with hinge (Gimbaled Roller) |
| G | Angular constraint (Fixed Roller) |
| H | Zero constraint (Castered and Gimbaled Roller) |
| TB (TURNOVER) | See FIG. 4 |
| I | Zero constraint (Castered and Gimbaled Roller) |
| J* | Angular constraint with hinge (Gimbaled Roller) |
| K | Angular constraint with hinge (Gimbaled Roller) |
| L | Angular constraint with hinge (Gimbaled Roller) |
| M | Angular constraint (Fixed Roller) |
| N | Zero constraint (Castered and Gimbaled Roller) |
| O | Angular constraint (out-feed drive roller) |
| P | Zero constraint (Castered and Gimbaled Roller) |
| Q | Angular constraint with hinge (Gimbaled Roller) |

Note:
Asterisk (*) indicates locations of load cells.

In this embodiment, an angular constraining fixed roller has been located at G, immediately after the print zone containing the printhead 16 and dryer 34, rather than in location F immediately preceding the printhead as in the first embodiment. To eliminate an over constraint condition in the span from roller F to G, fixed roller F of the previous configuration has been replaced with a gimbaled roller. In a similar manner the angular constraining fixed roller has been moved from location L to location M. This places the angular constraint on the print media in the print zone immediately after printhead 16. To eliminate an overconstraint condition in this configuration between the fixed roller M and the fixed drive roller O, a zero constraint castered and gimbaled roller N has been placed between those two fixed rollers.

In either the first or the second embodiment, the angular orientation of the print media in the print zone containing one or more printheads and possibly one or more dryers is controlled by a roller placed immediately before or immediately after the print zone. This is critical for ensuring registration of the print from multiple printheads. It is also critical that the web not be overconstrained in the print zone. This has been done by placing a constraint relieving roller at the opposite end of the print zone in each case; a castered roller following the print zone in the first embodiment and a gimbaled roller preceding the print zone in the second embodiment. As a result of the transit time of the print drops from the jetting module to the print media, variations in spacing of the printhead to the print media from one side of the printhead to the other, it is desirable to orient the printheads parallel to the print media. To maintain the uniformity of this spacing between the printhead and the print media, preferably the constraint relieving roller placed at one end of the print zone is not free to pivot in a manner that will alter the printhead to print media spacing. Therefore the gimbaled roller preceding the print zone in the second embodiment should not have a caster pivot as well. Similarly, the castered roller following the print zone in the first embodiment should preferably not include a gimbal pivot. The use of nonrotating supports under the media in the print zone as shown in FIG. 10 and FIG. 11 can be used to eliminate this design restriction.

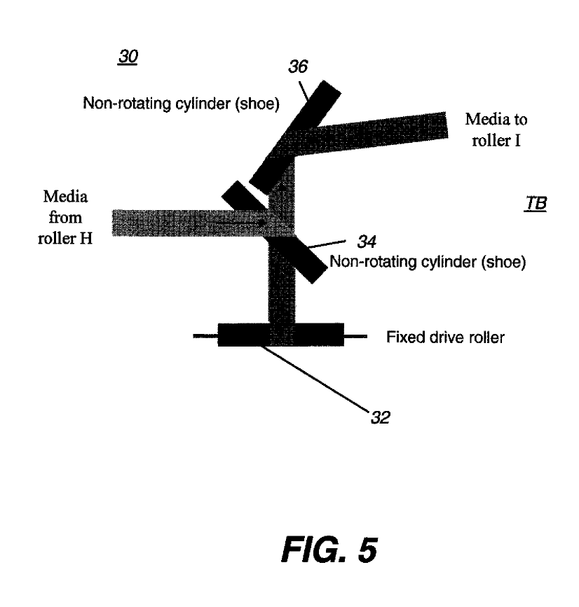

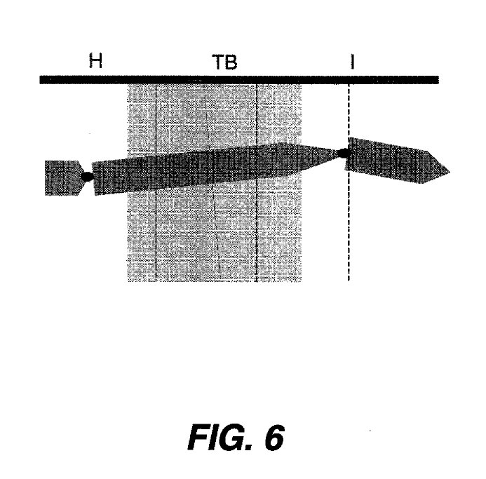

The top view of FIG. 5 and web plane diagram of FIG. 6 show the arrangement and constraint pattern, respectively, for turnover mechanism (TB) 30, shown as part of second module 40. Turnover mechanism TB can optionally be configured as a separate module, with its web media handling compatible with that of second module 40. The position of turnover mechanism TB is appropriately between print zones 54 for opposite sides of the media. Here, a fixed drive roller 32 of this device provides the single angular constraint. Lateral constraint is provided by the position of the moving web upstream of stationary turn-bar 34. Stationary turn-bars 34 and 36 are positioned at diagonals to the input and output paths and impart no constraint on the web as it slides over them. The use of a driven roller in the turnover mechanism, which can be driven independently of drive rollers B and N, allows the tension in the web to be separately maintained in the upstream and downstream of the turnover mechanism as will be discussed latter.

The system of the present invention is adaptable for a printing system of variable size and allows straightforward reconfiguration of a system without requiring precise adjustment and alignment of rollers and related hardware when modules are combined. The use of exact constraint mechanisms means that rollers can be mounted within the equipment frame or structure using a reasonable amount of care in mechanical placement and seating within the frame, but without the need to individually align and adjust each roller along the path, as would be necessary when using conventional paper guidance mechanisms. That is, roller alignment with respect to either the media path or another roller located upstream or downstream is not necessary.

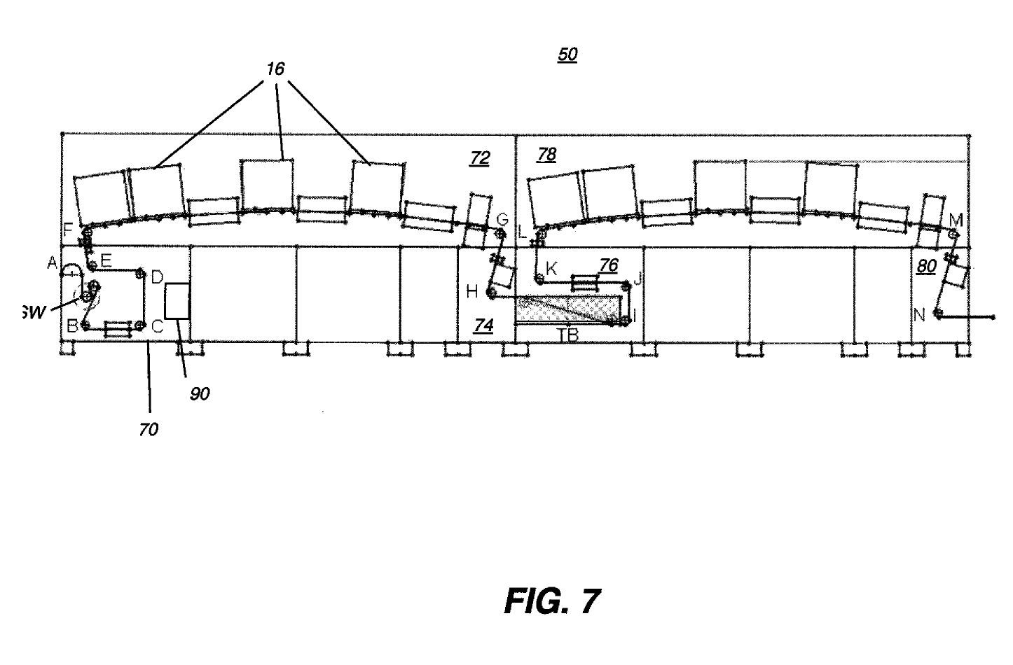

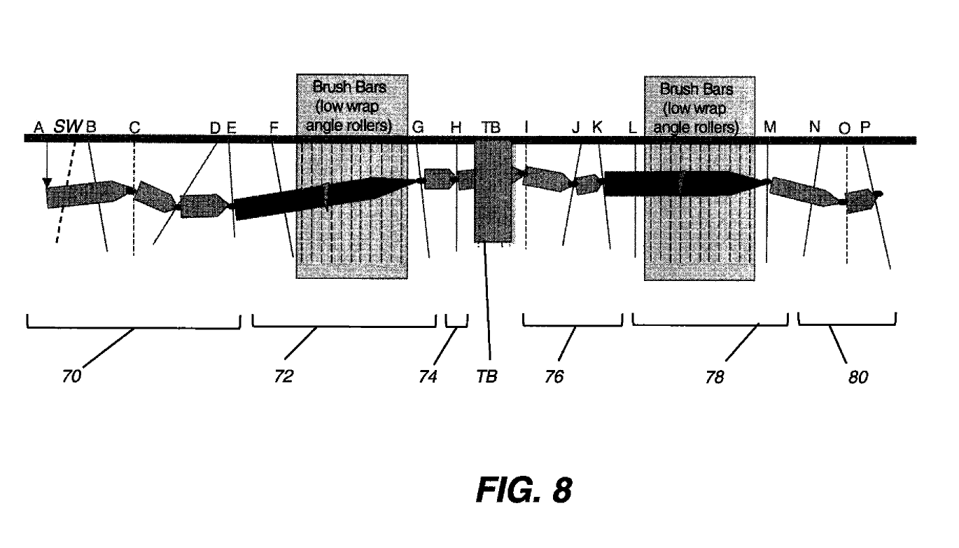

A digital printing system 50 shown schematically in FIG. 7 and with its web plane diagram shown in FIG. 8 has a considerably longer print path than that shown in FIG. 3, but provides the same overall sequence of angular constraints, with the same overall series of gimbaled, castered, and fixed rollers. Table 3 lists the roller arrangement used with the system of FIG. 7 in one embodiment. Brush bars, shown between rollers F and G and between L and M in FIGS. 7 and 8, are non-rotating surfaces and thus apply no lateral or angular constraint forces.

TABLE 3
Roller Listing for FIG. 7

| Media Handling | |
|---|---|
| Component | Type of Component |
| A | Lateral constraint (edge guide) |
| SW - S-Wrap | Zero constraint (non-rotating support) |
| B | Angular constraint (in-feed drive roller) |
| C | Zero constraint (Castered and Gimbaled Roller) |
| D* | Angular constraint with hinge (Gimbaled Roller) |
| E | Angular constraint with hinge (Gimbaled Roller) |
| F | Angular constraint (Fixed Roller) |
| G | Angular constraint with hinge (Gimbaled Roller) |
| H | Angular constraint with hinge (Gimbaled Roller) |
| TB (TURNOVER) | See FIG. 5 |
| I | Zero constraint (Castered and Gimbaled Roller) |
| J* | Angular constraint with hinge (Gimbaled Roller) |
| K | Angular constraint with hinge (Gimbaled Roller) |
| L | Angular constraint (Fixed Roller) |
| M | Angular constraint with hinge (Gimbaled Roller) |
| N | Angular constraint (out-feed drive roller) |
| O | Zero constraint (Castered and Gimbaled Roller) |
| P | Angular constraint with hinge (Gimbaled Roller) |

Note:
Asterisk (*) indicates locations of load cells.

Load cells are provided in order to sense web tension at one or more points in the system. In the embodiments of FIGS. 3 (Table 1), 7 (Table 3), and 10 (Table 2), load cells are provided at gimbaled rollers D and J. Control logic for the respective digital printing system 50 monitors load cell signals at each location and, in response, makes any needed adjustment in motor torque in order to maintain the proper level of tension throughout the system. For the embodiments of FIGS. 3, 7, and 10, the pacing drive component of the printing apparatus is the turnover module TB. There are two tension-setting mechanisms, one preceding and one following turnover module TB. On the input side, load cell signals at roller D indicate tension of the web preceding turnover module TB; similarly, load cell signals at roller J indicate web tension on the output side, between turnover module TB and take-up roll 18. Control logic for the appropriate in- and out-feed driver rollers at B and N, respectively, can be provided by an external computer or processor, not shown in Figures of this application. Optionally, an on-board control logic processor 90, such as a dedicated microprocessor or other logic circuit, is provided for maintaining control of web tension within each tension-setting mechanism and for controlling other machine operation and operator interface functions. As described, the tension in a module preceding the turn bar and a module following the turnover module TB can be independently controlled relative to each other further enhancing the flexibility of the printing system. In this example embodiment, the drive motor is included in the turnover module TB. In other example embodiments, the drive motor need not be included in a turnover mechanism. Instead, the drive motor can be appropriately located along the web path so that tension within one module can be independently controlled relative to tension in another module.

The configurations of FIGS. 1, 3, and 10 were described as including two modules 20 and 40. In the FIG. 1 configuration, each module provided a complete printing apparatus. However, the “modular” concept need not be restricted to apply to complete printers. Instead, the configuration of FIG. 7 can be considered as formed of as many as seven modules, as follows:
(1) An entrance module 70 is the first module in sequence, following the media supply roll, as was shown earlier with reference to FIG. 1. Entrance module 70 provides the edge guide A that positions the media in the cross-track direction and provides the S-wrap SW or other appropriate web tensioning mechanism. In the embodiment of FIG. 7, entrance module 70 provides the in-feed drive roller B that cooperates with SW and other downstream drive rollers to maintain suitable tension along the web, as noted earlier. Rollers C, D, and E are also part of entrance module 70 in the FIG. 7 embodiment.
(2) A first printhead module 72 accepts the web media from entrance module 70, with the given edge constraint, and applies an angular constraint with fixed roller F. A series of stationary brush bars or, optionally, minimum-wrap rollers then transport the web along past a first series of printheads 16 with their supporting dryers and other components. Here, because of the considerable web length in the web segment beyond the angular constraint provided by roller F (that is, the distance between rollers F and G), that segment can exhibit flexibility in the cross track direction which is an additional degree of freedom that needs to be constrained. Eliminating the expected caster of roller G provides the additional constraint needed in that span.
(3) An end feed module 74 provides an angular constraint to the incoming media from printhead module 72 by means of gimbaled roller H.
(4) Turnover module TB accepts the incoming media from end feed module 74 and provides an angular constraint with its drive roller, as described previously.
(5) A forward feed module 76 provides a web span corresponding to each of its gimbaled rollers J and K. These rollers again provide angular constraint only; the lateral constraint for web spans in module 76 is obtained from the edge of the incoming media itself.
(6) A second printhead module 78 accepts the web media from forward feed module 76, with the given edge constraint, and applies an angular constraint with fixed roller L. A series of stationary brush bars or, optionally, minimum-wrap rollers then feed the web along past a second series of printheads 16 with their supporting dryers and other components. Here again, because of considerable web length in the web segment (that is, extending the distance between rollers L and M), that segment will exhibit flexibility in the cross track direction which is an additional degree of freedom that needs to be constrained, eliminating the expected caster of roller M provides the additional constraint needed in that span. When overhang is present in the web span (that is, extending the distance between rollers L and M), exact constraint principles may be difficult to apply successfully. Gimbaled roller M provides additional constraint over this long web span.
(7) An out feed module 80 provides an out-feed drive roller N that serves as angular constraint for the incoming web and cooperates with other drive rollers and sensors along the web media path that maintain the desired web peed and tension. Optional rollers O and P (not shown in FIG. 7) may also be provided for directing the printed web media to an external accumulator or take-up roll.

Annotation in FIG. 8 shows this modular breakdown.

Each module in this sequence provides a support structure and an input and an output interface for kinematic connection with upstream or downstream modules. With the exception of the first module in sequence, which provides the edge guide at A, each module utilizes one edge of the incoming web media as its “given” lateral constraint. The module then provides the needed angular constraint for the incoming media in order to provide the needed exact constraint or kinematic connection of the web media transport. It can be seen from this example that a number of modules can be linked together using the apparatus and methods of the present invention. For example, an additional module could alternately be added between any other of these modules in order to provide a useful function for the printing process.

Using the apparatus and methods of the present invention, module function can be adapted to the configuration of the complete printing system. In many cases, rollers and components can be interchangeable, including rollers at the interface between modules, moved from one module to another as best suits the printer configuration. Frames and other support structures for the different modules can use a standard design and dimensions or can be designed differently according to the contemplated application. This also helps to simplify upgrade situations.

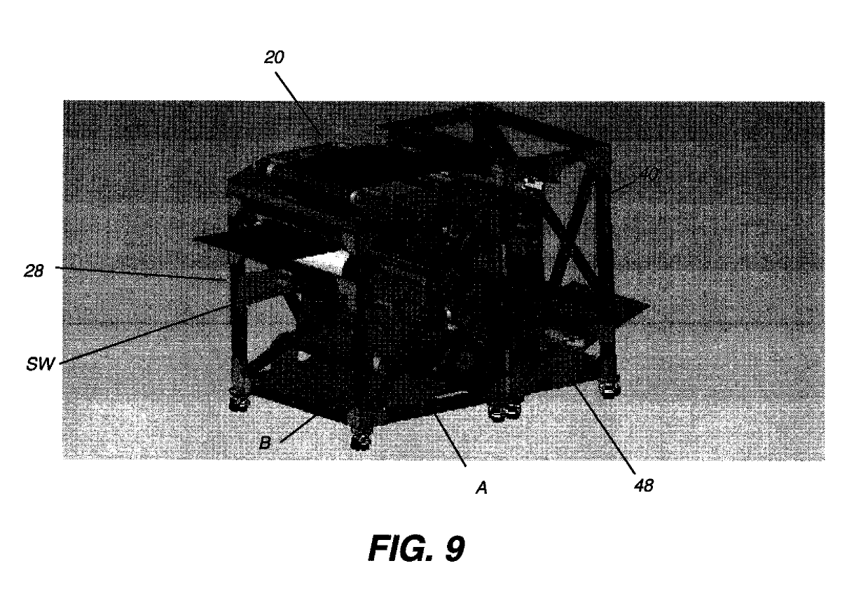

The perspective view of FIG. 9 shows two interconnected modules 20 and 40 in one embodiment. A support structure 28, shown without covers and without printhead and supporting dryer for visibility of internal components, provides a supporting frame for mounting components within module 20. Similarly, a support structure 48 provides a supporting frame for mounting components within module 40.

There are a number of ways to track web position in order to locate and position inkjet dots or other marking that is made on the media. A variety of encoding and sensing devices could be used for this purpose along with the necessary timing and synchronization logic, provided by control logic processor 90 or by some other dedicated internal or external processor or computer workstation. Such encoders or sensing devices are typically placed just upstream of the print zone containing the one or more printheads, and are preferably placed on a fixed roller so as to avoid interfering with self aligning characteristic of castered or gimbaled rollers.

In order to provide a digital printing system for non-contact printing onto a continuous web of print media at high transport speeds, the apparatus and method of the present invention apply a number of exact constraint principles to the problem of web handling, including the following:
(a) Employing, over each web span, a pairing of lateral and angular constraints, with the angular constraint downstream of the lateral constraint. Over each web span subsequent to the first web span in the system, the method uses the given lateral position of the web as the given edge-constraint.
(b) Use of zero-constraint castered rollers, non-rotating surfaces, or low wrap angle rollers where it is necessary to guide the media without constraint. This is the case, for example, where there is an overhang condition, where some length of the web within a web span extends past the angular constraint for that web span.
(c) Use of gimbaled rollers where necessary to provide an angular constraint, taking advantage of the capability of the web to twist without overconstraint. Use of gimbaled only rollers where necessary to provide an angular constraint in the web span immediately upstream while imparting no angular constraint in the web span immediately downstream of that roller.

An active steering mechanism could be used within a web span, such as where the web span length of an overhang exceeds its width, so that the web no longer has sufficient mechanical stiffness for exact constraint techniques. This can happen, for example, where there is considerable overhang along the web span, that is, length of the web extending beyond the angular constraint for the span. This is the case for modules 72 and 78 in the embodiment described with respect to FIG. 7. In such a case, a castered roller in the overhang section of the web may no longer behave as a zero constraint, since some amount of lateral force from the web is needed in order to align the castered roller mechanism to the angle of the web span. This under-constraint condition, due to length of the overhang along this lengthy web span, can be corrected by application of an additional constraint.

Kinematic connection between modules 20 and 40 follows the same basic principles that are used for exact constraint within each web span. That is, cross-track or edge alignment is taken from the preceding module. Any attempt to re-register the media edge as it enters the next module would cause an overconstraint condition. Rather than attempting to steer the continuously moving media through a rigid and potentially over-constrained transport system, the media transport components of the present invention self-align to the media, thereby allowing good registration at high transport speeds and reducing the likelihood of damage to the media or misregistration of applied ink or other colorant to the media.

Where multiple modules are used, as was described with reference to the embodiment shown in FIG. 7, it is important that the system have a master drive roller that is in control of web transport speed. Multiple drive rollers can be used and can help to provide proper tension in the web transport (x) direction, such as by applying suitable levels of torque, for example. In one embodiment, the turnover TB module drive roller acts as the master drive roller. The in-feed drive roller at B in module 20 adjusts its torque according to a load sensing mechanism or load cell that senses web tension between the drive and in-feed rollers. Similarly, out-feed drive roller N can be controlled in order to maintain a desired web tension within second module 40.

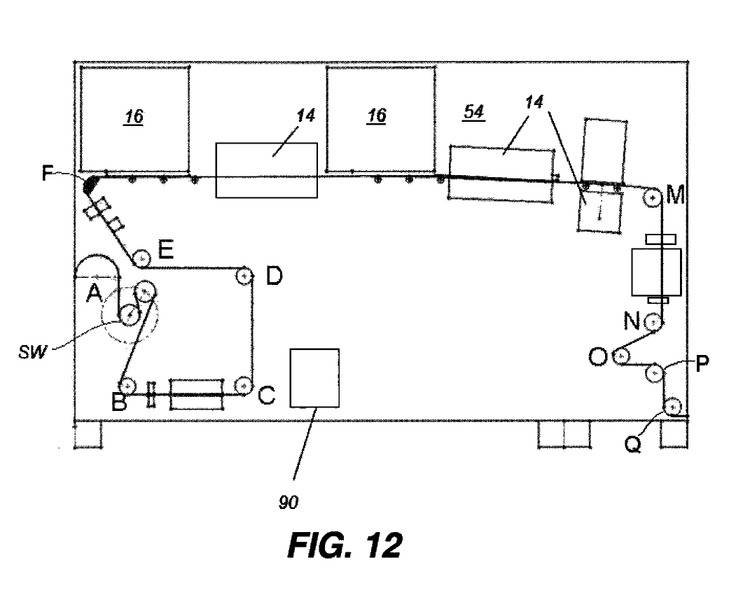

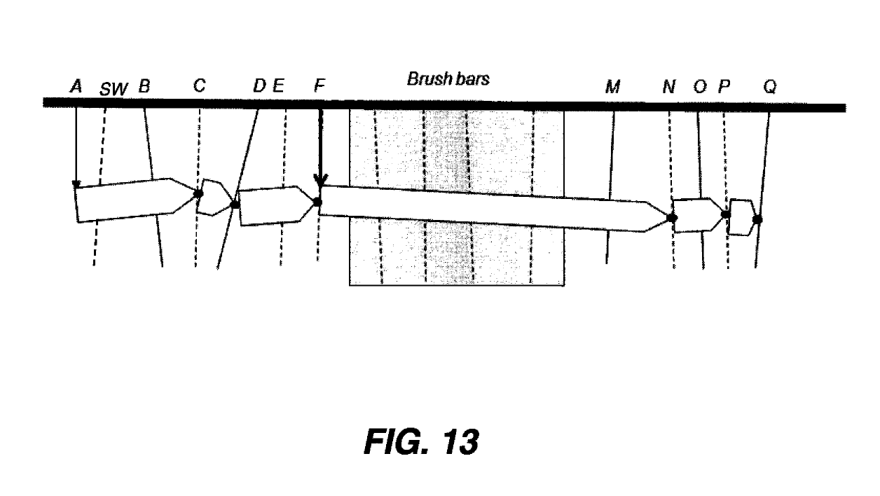

FIG. 12 shows another embodiment of the present invention. The constraints provided by each roller are listed in table 4 and are illustrated in a web plane diagram in FIG. 13. In this embodiment, the web position in the span containing the printheads 16 and dryers 14 is defined by a lateral constraint in the form of an edge guide F located immediately before the print zone and an angular constraint, non-pivoting roller M, located immediately after the print zone. With the media under tension as it wraps around the shoe of the edge guide F, it is necessary to have the shoe free to pivot. This ensures that the media has uniform tension across its width in the print zone. In this embodiment the shoe is allowed to rotate about an axis at the center of the shoe and perpendicular to the plane of the web segment from F to M. This rotation orientation eliminates any variation in spacing between the media and printheads 16 as shoe F pivots. (When the media is not under tension as it passes over the edge guide, the edge guide shoe need not be free to pivot.) This embodiment also has an edge guide A and a non-pivoting drive roller B that establish an initial path for the media in the first span of the media entering the printing system. The combination of the castered and gimbaled rollers C and E and the gimbaled roller D eliminate an overconstraint condition that would have existed between the first media span and the span across the print zone. Edge guide A helps to ensure that the only minor shifting of the lateral position of the web is needed at edge guide F. This allows the bias force needed to shift the media to the edge stop to be kept to a minimum. (With the media under tension as it passes edge guide F, the required bias force to shift the media is greater than it would be if the media were not under tension.)

TABLE 4
Roller Listing for FIG. 12

| Media Handling | |
|---|---|
| Component | Type of Component |
| A | Lateral Constraint (Edge Guide) |
| SW - S-Wrap | Zero Constraint (Non-Rotating Support). |
| | Tensioning. |
| B | Angular Constraint (In-Feed Drive Roller) |
| C | Zero Constraint (Castered and Gimbaled Roller) |
| D* | Angular Constraint with Hinge (Gimbaled Roller) |
| E | Zero Constraint (Castered and Gimbaled Roller) |
| F | Lateral Constraint (Edge Guide) |
| Brush Bars | Zero Constraint (Non-Rotating Support) |
| M | Angular Constraint (Non-Pivoting Roller) |
| N | Zero Constraint (Castered and Gimbaled Roller) |
| O | Angular Constraint (Out-Feed Drive Roller) |
| P | Zero Constraint (Castered and Gimbaled Roller) |
| Q | Angular Constraint with Hinge (Gimbaled Roller) |

Note:
Asterisk (*) Indicates Locations Of Load Cells.

In this embodiment of FIG. 12, the printing system doesn't comprise multiple modules. All the media transport components are secured to a single support structure. Through the use of rollers that will align to the web, it is not necessary to precisely align the rollers to each other in this system. This greatly reduces the assembly costs for the system. As precise alignments are not required, the support structure to which the various rollers and web guides are mounted doesn't need to be as stiff as prior art frames. This allows the mass of the support structure to be greatly reduced which reduces shipping and setup costs.

It can be seen that the method of the present invention can be applied for handling continuous web media transport within and between one, two, three, or more modules applying exact constraint techniques. This flexibility allows a web transport arrangement that provides good registration and repeatable performance at high speeds commensurate with the requirements of high-speed color inkjet printing. As has been shown, multiple modules can be integrated to form a printing system, without the requirement for painstaking alignment of rollers or other media handling components at the interface between two modules.

It has been found that web transports systems as described above maintain effective control of the print media in the context of a digital print system where the selected portions of the print media are moistened in the printing process. This is true even when the print media is prone to expanding in length and width and to becoming less stiff when it is moistened, such as for cellulose based print media moistened by a water based ink. This enables the individual color planes of a multi-colored document to be printed with good registration to each other.

The digital printing systems having one or more printheads that selectively moisten at least a portion of the print media as described above include a media transport system that serves as a support structure to guide the continuous web of print media. The support structure includes an edge guide or other mechanism that positions the print media in the cross track direction. This first mechanism is located upstream of the printheads of the digital printing system. The print media is pulled through the digital printing system by a driven roller that is located downstream of the printheads. The systems also include a mechanism located upstream of printheads of the printing system for establishing and setting the tension of the print media. Typically it is also located downstream of the first mechanism used for positioning the print media in the cross track direction. The transport system also includes a third mechanism to set an angular trajectory of the print media. This can be a fixed roller (for example, a non-pivoting roller) or a second edge guide. The printing system also includes a roller affixed to the support structure, the roller being configured to align to the print media being guided through the printing system without necessarily being aligned to another roller located upstream or downstream relative to the roller. The castered, gimbaled or castered and gimbaled rollers serve in this manner.

As noted earlier, slack loops are not required between or within modules. Slack loops can be appropriate where the continuous web is initially fed from a supply roll or as it is re-wound onto a take-up roll, as was described with reference to the printing apparatus of FIG. 1.

The invention has been described in detail with particular reference to certain preferred embodiments thereof, but it will be understood that variations and modifications can be effected within the scope of the invention.

### PARTS LIST

10. Printing system
12. Source roller
14. Dryer
16. Digital printhead
18. Take-up roll
20. Module
22. Cross-track positioning mechanism
24. Tensioning mechanism
26. Constraint structure
28. Support structure
30. Turnover mechanism
32. Drive roller
34, 36. Turn bar
40. Module
48. Support structure
50. Digital printing system
52. Slack loop
54. Print zone
60. Web
62. Edge (support structure)
64. Lateral constraint
66. Angular constraint
68 Zero constraint
70. Entrance module
72. Printhead module
74. End feed module
76. Forward feed module
78. Printhead module
80. Out-feed module
90. Control logic processor
A, B, C, D, E, F, G, H, I, J, K, L, M, N, O, P. Rollers
SW. S-wrap
TB. Turnover module

1. A digital printing system for printing on a continuous web of print media comprising:
a support structure that guides a continuous web of print media under tension through the printing system, the support structure including:
a first mechanism affixed to the support structure, the first mechanism including structure that positions the print media in a cross track direction;
a second mechanism affixed to the support structure, the second mechanism including structure that sets tension of the print media;
a third mechanism affixed to the support structure, the third mechanism including structure that sets an angular trajectory of the print media;
a roller affixed to the support structure, the roller being configured to align to the print media being guided through the printing system without necessarily being aligned to another roller located upstream or downstream relative to the roller; and
a drive roller affixed to the support structure, the drive roller being configured to move the print media through the printing system; and
a printhead located downstream relative to the first mechanism, the printhead being configured to selectively moisten at least a portion of the print media being guided through the printing system without contacting the print media.

2. The system of claim 1, wherein the third mechanism immediately precedes the printhead.

3. The system of claim 1, wherein the third mechanism immediately follows the printhead.

4. The system of claim 3, wherein the first mechanism immediately precedes the printhead.

5. The system of claim 1, the printhead being located in a print zone, the print zone further comprising a dryer positioned downstream relative to the printhead.

6. The system of claim 5, wherein the third mechanism immediately follows the print zone.

7. The system of claim 1, further comprising:
a turnover mechanism configured to turn the print media over, the turnover mechanism being located downstream relative to the printhead.

8. The system of claim 7, the printhead being a first printhead, the system further comprising:
a second printhead positioned downstream relative to the turnover mechanism.

9. The system of claim 7, wherein the turnover mechanism includes a driven roller.

10. The system of claim 1, wherein the third mechanism immediately follows the print zone.

11. The system of claim 10, wherein the first mechanism immediately precedes the print zone.

12. The system of claim 1, wherein the first mechanism includes an edge guide.

13. The system of claim 1, wherein the structure of the second mechanism does not constrain the print media.

14. The system of claim 1, wherein the second mechanism is located along the media path between a source of the print media and the driver roller.

15. The system of claim 1, wherein the third mechanism includes a gimbaled roller.

16. The system of claim 1, wherein the third mechanism immediately precedes the print zone.

17. A method of printing on a continuous web of print media comprising:
guiding a continuous web of print media under tension through a printing system by:
positioning the print media in a cross track direction using a first mechanism;
setting a tension of the print media using a second mechanism; and
setting an angular trajectory of the print media using a third mechanism;
causing the print media to move through the printing system using a drive roller; and
selectively moistening at least a portion of the print media being guided through the printing system without contacting the print media using a printhead located downstream relative to the first mechanism.

18. The method of claim 17, further comprising:
aligning the print media being guided through the printing system using a roller that is not necessarily aligned to another roller located upstream or downstream relative to the roller.
